(19) United States
(12) Patent Application Publication
(10) Pub. No.: US 2015/0088807 A1
(43) Pub. Date: Mar. 26, 2015

(54) SYSTEM AND METHOD FOR GRANULAR SCALABILITY IN ANALYTICAL DATA PROCESSING

(71) Applicant: Infobright Inc., Toronto (CA)

(72) Inventors: Graham Toppin, North York (CA); Janusz Borkowksi, Warszawa (PL); Dominik Slezak, Warszawa (PL); Shengli Shi, Toronto (CA); Piotr Synak, Warszawa (PL); Jakub Wroblewski, Lomianki (PL); Todd Joseph Wongkee, Toronto (CA); George Charalabopoulos, Toronto (CA)

(21) Appl. No.: 14/497,290

(22) Filed: Sep. 25, 2014

Related U.S. Application Data
(60) Provisional application No. 61/882,609, filed on Sep. 25, 2013.

(51) Int. Cl. G06F 17/30

(52) U.S. Cl. CPC G06F 17/30563; G06F 17/30595; G06F 17/30545
USPC 707/602

(57) ABSTRACT

A method of resolving data queries in a data processing system. The method comprises receiving in the data processing system a data query, where the data processing system stores a plurality of information units describing pluralities of data elements, a first information unit having a retrieval subunit that includes information for retrieving all unique data elements in a first plurality of data elements and a summary subunit including summarized information about data elements in the first plurality of data elements. The method further includes deriving, via the data processing system, a result of the data query, wherein the result of the data query comprises a plurality of new data elements. The data processing system uses summary subunits of information units to select a set of information units describing data elements that are sufficient to resolve the data query.

### CROSS REFERENCE TO RELATED APPLICATIONS

The present application claims priority to and the benefit of U.S. Provisional Application Ser. No. 61/882,609 filed on 25 Sep. 2013, which is incorporated herein by reference in its entirety.

### TECHNICAL FIELD

The present disclosure relates generally to relational database management systems (RDBMS), and more particularly to system and method for processing query requests in RDBMS.

### BACKGROUND

In the present disclosure, where a document, an act and/or an item of knowledge is referred to and/or discussed, then such reference and/or discussion is not an admission that the document, the act and/or the item of knowledge and/or any combination thereof was at the priority date, publicly available, known to the public, part of common general knowledge and/or otherwise constitutes prior art under the applicable statutory provisions; and/or is known to be relevant to an attempt to solve any problem with which the present disclosure may be concerned with. Further, nothing is disclaimed.

Over the last decade there has been a significant increase in data sizes and data change rates that organizations need to deal with on daily basis. This proliferation of data is a result of an increase in the number of devices, services and people connected in an increasingly complex environment. Such new kinds of data sources represent a challenge and an opportunity. An opportunity is to create compelling products and services driven by analytics. A challenge is to manage incredibly large data volumes in an agile, cost effective manner. Companies able to meet this challenge will likely have a competitive advantage. This is related to an already observed shift from differentiation of products to differentiation of analytics, also described as the shift from product driven to data driven industry.

Systems analyzing data related to machine-to-machine communication can be referred to as machine generated data analytical systems. Such systems address the problems of interactive analytics over large, complex, heterogeneous data sets. “Large” refers to data sets that are significant in terms of their cardinality and raw data size. “Complex” refers to large numbers and variety of non-obvious relationships between data elements. “Heterogeneous” refers to the number and type of data sources comprising the data.

A number of architectural paths can be taken to facilitate the needs of above systems. One of them can be referred as data silo, where data is stored at a single point and used there. A data silo integrates with other systems, but this is secondary to data retention and analysis. This kind of integrated information is powerful, although its achievement requires very sophisticated tools in case of huge and heterogeneous data sources. An alternative path can be referred as data fabric, where data is consumed from multiple points, and not even necessarily loaded. Most of solutions today focus on the silo model of data acquisition and querying. Indeed, it is possible to achieve analytical scalability over machine generated data by utilizing the existing data silo tools, though it is usually a huge technical and financial investment.

Data fabric based solutions are especially useful in case of data sets that are geographically dispersed, i.e., created in a distributed way, which raises a number of challenges and opportunities. It is important to adjust to their geography with data processing units. It would be beneficial to be able to adjust to their geography in a natural way, which would also help with scalability with respect to utilization of multi-machine resources.

On top of that, while data quantity and complexity will become arbitrarily large, the speed of obtaining results will become even more critical than today. This tendency influences expectations with regard to scalability of analytical database systems. In particular, scalability should refer to acceleration of both standard operations and their approximate counterparts. Such functionality should come together with appropriate interfaces and configuration templates letting users specify how they wish to mix standard query workloads with approximate or semi-approximate operations.

### SUMMARY

The present disclosure is an example of a data fabric style of solution, optimized particularly with regard to the analysis and exploration of rapidly growing machine generated data sets. The present systems and methods for solving the underlying computational scalability problems incorporate a specific application of the principles of rough sets and granular computing in combination with the principles of distributed processing. The present disclosure refers to implementations of a rough computing engine, which is one example of a methodology performing scalable data operations according to the four following principles: Specifying how to decompose data onto granules, creating approximate snapshots for each of the granules, conducting approximate computations on snapshots, and, whenever there is no other way to finish a query execution, iteratively retrieving the content of some of granules. One of the key aspects of the present disclosure is to establish an abstraction layer between the methods conducting approximate computations on snapshots and the methods of retrieving the contents of granules maintained in various forms and various locations. We will call this abstraction layer a knowledge fabric. Knowledge fabric is one example of implementation of a data fabric methodology, wherein an interface between data computation and data storage layers is designed by means of operating with knowledge about data rather than the data itself, including without limitation operating based on predetermined statistics describing the actual data (e.g., an embodiment of such statistics describing the actual data may be maximum, minimum, average, mean, as well as other statistical descriptions of actual data).

Additionally, in embodiments of the present disclosure, analytical logic is pushed down directly to distributed data processing units, thereby producing data aggregations prior to a typical database level of data analytics.

A system and method of the present disclosure also provides an optimal input for analytical algorithms, letting users easily balance between how quickly and how accurately they want to compute results. The data inputs often do not need to be accurate because they are usually evolving extremely fast. Therefore, long cycles like in the case of typical analytical software applications are not preferred. A system and method of the present disclosure includes an intermediate analytical layer that is closer to the boundary between analytics and data. Depending on a context of particular analytical operations, the systems and methods of the present disclosure can support different models of partial or eventual consistency between granules representing pluralities of data elements and snapshots including summarized information about those pluralities. The methods and systems for such a contextual query environment can be further configured to use different types of snapshots and different policies of retrieving granules from local or remote data sources. Therefore, for certain types of queries, long cycles can be replaced by faster operations working dynamically with the evolving distributed data.

Besides ability to work with dynamically growing distributed data and contextual queries, the methods and systems of the present disclosure allow the quick and easy deployment of small, purpose built software agents, known as knowledge processors, to multiple machines and devices. Knowledge processors can be deployed in a disconnected or connected fashion. In some embodiments, knowledge processors can be configured as rough computing engines that retrieve summaries and details of data granules from so called knowledge fabric and are able to communicate with each other, requesting for summaries of newly created data. Together with the data abstraction layer provided by knowledge fabric, knowledge processors constitute so called scalable knowledge framework.

In some embodiments scalable knowledge provides a means for ad-hoc analytics on disperse and dynamically changing large scale data sets, via distributed loading and querying against a grid of data summaries in a distributed environment. Furthermore, in some embodiments scalable knowledge provides for the creating and mixing of different policies of maintaining summaries related to historical data, depending on the requirements related to accuracy of data operations. In some embodiments scalable knowledge also provides for the creation of data in a distributed form. Also, in some embodiments distributed data will be provided as dynamic data. In some embodiments, the data model should not force the users to delete historical data, although some nodes may contain more historical data than others.

In some embodiments scalable knowledge compromises on the overall exact performance of the system to offer a richer analytical and visualization feature set and scalable approximate query models in a manner that does not require an inordinate amount of resources to deploy. Furthermore, in some embodiments, scalable knowledge provides seamless context between approximate models, that is, providing a user with the ability to query exactly and/or approximately, as well as providing varying results, filters and criteria all within the same query.

In some embodiments scalable knowledge allows for representing large scale results of operations on machine generated data sets. Furthermore, in some embodiments scalable knowledge provides for managing knowledge clusters in a heterogeneous environment including large numbers of different data systems (e.g., operating systems, machine architectures, communication protocols) and data types (structured/semi-structured/unstructured), by means of specifications how, and at which level of granularity, to dynamically process the data content and how to link it to knowledge fabric layer, so it can be efficiently queried by knowledge processors.

Scalable knowledge overcomes the problems with prior systems in which the users' ability to query the data with reasonable response time is hampered, the systems required to process and store the data rapidly become costly and cumbersome, and the complexity of the environment for scalable analytics of machine generated data requires significant administration.

In one embodiment, a method of resolving data queries in a data processing system is provided. The method comprises receiving in the data processing system a data query, where the data processing system stores a plurality of information units describing pluralities of data elements, a first information unit having a retrieval subunit that includes information for retrieving all unique data elements in a first plurality of data elements and a summary subunit including summarized information about data elements in the first plurality of data elements. The method further includes deriving, via the data processing system, a result of the data query, wherein the result of the data query comprises a plurality of new data elements. The data processing system uses summary subunits of information units to select a set of information units describing data elements that are sufficient to resolve the data query, retrieval subunits of information units in the selected set of information units to retrieve data elements sufficient to resolve the data query, and retrieved data elements and summary subunits of information units stored by the data processing system to resolve the data query. The method further includes returning the result of the data query.

In another embodiment, the first information unit includes a plurality of summary subunits and a plurality of retrieval subunits, wherein the data processing system chooses a first summary subunit of the first information unit and a first retrieval subunit of the first information unit to be used while resolving the data query according to at least one of a predefined scenario of a usage of the data processing system and an interaction with a user of the data processing system via an interface.

In another embodiment, the first information unit does not belong to the set of information units selected as describing data elements that are sufficient to resolve the data query, and wherein the first plurality of data elements is retrieved to be used while resolving the data query resulting from at least one of an interaction with a user of the data processing system via an interface, and a likelihood that the summary subunit of the first information unit is inconsistent with the first plurality of data elements.

In another embodiment, the first information unit belongs to the set of information units selected as describing data elements that are sufficient to resolve the data query, and wherein the first plurality of data elements is not retrieved as a result of at least one of an interaction with a user of the data processing system via an interface, and a constraint for a maximum allowed amount of data elements that can be retrieved while resolving the data query, the method further comprising heuristically creating two pluralities of artificial data elements, wherein both created pluralities are consistent with the summary subunit of the first information unit, deriving two artificial results of the data query, wherein a first artificial result is obtained by using a first plurality of artificial data elements and a second artificial result is obtained by using a second plurality of artificial data elements, creating two new information units describing artificial results of the data query, wherein the summary subunit of a first new information unit includes a summarized information about the first artificial result and the summary subunit of a second new information unit includes a summarized information about the second artificial result, returning the first artificial result as the result of the data query with an additional information about its accuracy, wherein the accuracy of the result is heuristically measured based on a degree of similarity between the summarized information about the first artificial result and the summarized information about the second artificial result.

In another embodiment, the data processing system further connected to a plurality of data systems, wherein the first plurality of data elements is stored in a first data system and the retrieval subunit of the first information unit specifies how to retrieve the first plurality of data elements from the first data system, and wherein the first data system takes a form of at least one of the following a distributed file system, wherein the first plurality of data elements is stored in a first file and the retrieval subunit of the first information unit specifies a directory of the first file and a location of the first plurality of data elements in the first file, a key-value store, wherein the first plurality of data elements is stored as a value in a first key-value pair and the retrieval subunit of the first information unit specifies the key of the first key-value pair, a data system which is at least one of: a relational database system, a statistical data analysis platform, or a document store, and wherein the retrieval subunit of the first information unit specifies a method of acquiring the first plurality of data elements as a result of at least one of: a SQL statement, a statistical operation, or a text search query.

In another embodiment, data elements in the first plurality of data elements are information units describing pluralities of more detailed data elements, and wherein the summary subunit of the first information unit includes a summarized information about all pluralities of more detailed data elements described by information units in the first plurality of information units.

In another embodiment, the data processing system further comprises a document store, wherein a first document in the document store includes the first plurality of information units, a metadata of the first document in the document store includes the summarized information about all more detailed data elements described by information units in the first plurality of information units, and a key of the first document in the document store encodes a context of using the first plurality of information units by the data processing system.

In another embodiment, the data query is specified against a relational data model, and wherein at least one of the following the first plurality of information units represents values of tuples in a first cluster of tuples over a first column in a first table of the relational data model and the key of the first document in the document store encodes an identifier of the first table, an identifier of the first column, and an identifier of the first cluster of tuples, and the first plurality of information units represents vectors of values of tuples in the first cluster of tuples over a set of columns in the first table of the relational data model and the key of the first document in the document store encodes the identifier of the first table and the identifier of the first cluster of tuples in the first table.

In another embodiment, the total information included in the retrieval subunit and the summary subunit of the first information unit represents less information than all unique data elements in the first plurality of data elements.

In another embodiment, the data processing system further comprises a plurality of processing agents, wherein the first processing agent is connected with the data processing system and other processing agents via a communication interface.

In another embodiment, the data processing system assigns the first processing agent to store the first plurality of data elements, and wherein the assignment is made according to at least one of a predefined maximum amount of data elements allowed to be stored by the first processing agent or a degree of similarity of the summary subunit of the first information unit to summary subunits of information units describing pluralities of data elements stored by the first processing agent.

In another embodiment, the data processing system assigns the first processing agent to resolve the data query, and wherein the assignment is made according to an amount of data elements selected as sufficient to resolve the data query that are not stored by the first processing agent comparing to other processing agents.

In another embodiment, the data query is received together with an execution plan including a sequence of data operations, a result of a last data operation representing the result of the data query, the method further comprising using summary subunits of information units stored by the data processing system to select a set of information units describing data elements that are sufficient to resolve the first data operation, assigning the first processing agent to resolve the first data operation and using retrieval subunits of information units in the selected set of information units to retrieve data elements that are sufficient to resolve the first data operation, deriving a result of the first data operation as a plurality of new data elements and creating a new information unit, wherein its retrieval subunit specifies how to access the result of the first data operation at the first processing agent and its summary subunit includes a summarized information about the result of the first data operation, and returning the new information unit for further use by the data processing system.

In another embodiment, there are at least two data operations in the execution plan, the method further comprising if resolving a second data operation requires the result of the first data operation, then using the summary subunit of the new information unit describing the result of the first data operation to select a set of information units describing data elements that are sufficient to resolve the second data operation, and if resolving the second data operation does not require the result of the first data operation, then assigning a second processing agent to resolve the second data operation and resolving the second data operation in parallel to the first data operation.

### BRIEF DESCRIPTION OF THE DRAWINGS

FIG. 1 is a system diagram depicting a knowledge processor as a local computational unit in accordance with an embodiment of the present disclosure;

FIG. 2 depicts a diagram representing an example of a simple query involving two numeric attributes in accordance with an embodiment of the present disclosure;

FIG. 3 is a diagram illustrating an example of an operation of randomized simulation of a content in accordance with an embodiment of the present disclosure;

FIG. 4 is a diagram illustrating an embodiment of a design of a distribution of an aggregation query onto multiple knowledge processors in accordance with the present disclosure in a networked environment;

FIG. 5 is a diagram illustrating a structure for maintaining information about data in the knowledge fabric in accordance with the present disclosure in a networked environment;

FIG. 6 is a diagram illustrating an embodiment of mapping of the keys onto a relational data model in accordance with the present disclosure in a networked environment;

FIG. 7 is a diagram illustrating a scalable knowledge system in accordance with an embodiment of the present disclosure;

FIG. 8 is diagram that summarizes the parameters responsible for organization of the incoming data in accordance with an embodiment of the present disclosure;

FIG. 9 depicts a data layout parameters in an embodiment of the present disclosure;

FIG. 10 is a diagram illustrating an embodiment of a system where different knowledge processors work in different modes; and

FIG. 11 is a flow chart illustrating an embodiment of a method for query result determination by the knowledge processor of FIG. 1.

### DETAILED DESCRIPTION

Let us begin with already quite widely known statement that data becomes pervasive. The next generation of platforms, services, devices will need an easy way to analyze associated data. The tasks remain the same: Predict, Investigate, Optimize. However, as the data quantity and complexity become arbitrarily large, time to answer becomes more important, and exactness of most answers becomes less important.

Data represents a challenge and an opportunity. The opportunity is to create compelling products and services, driven by analytics. A challenge is to manage incredibly large volumes of data, in an agile, cost effective manner. In this connected universe, machine-to-machine communication is where the most meaningful data and information is generated. The data generated by machines and their interactions is growing substantially quicker than the machines themselves. Competition is increasingly driven by analytics, and analytics is driven by data.

Consumer experience is becoming vertically enhanced as well. Consider smart phones, smart homes, smart buildings, or smart accessories. In order to facilitate above needs, a number of architectural paths are proposed. As previously stated, the first of them can be referred as a data silo, where data is stored at a single point and used there. A data silo integrates with other systems, but this is secondary to the data retention and analysis. Certainly, integrated information provides significant power, although its achievement requires very sophisticated tools in case of huge, heterogeneous and often partially incompatible data sources.

Another path is referred to as data fabric, where data is consumed from multiple points, and not even necessarily loaded. Analysis is then distributed between multiple nodes. Most solutions today focus on the silo model of data acquisition and queries. Achieving analytical scalability by utilizing existing tools is usually a burdensome technical and financial investment. On the other hand, as discussed in detail below, the present systems and methods of data fabric oriented scalable knowledge framework can reach the formulated goals in a faster, more flexible way.

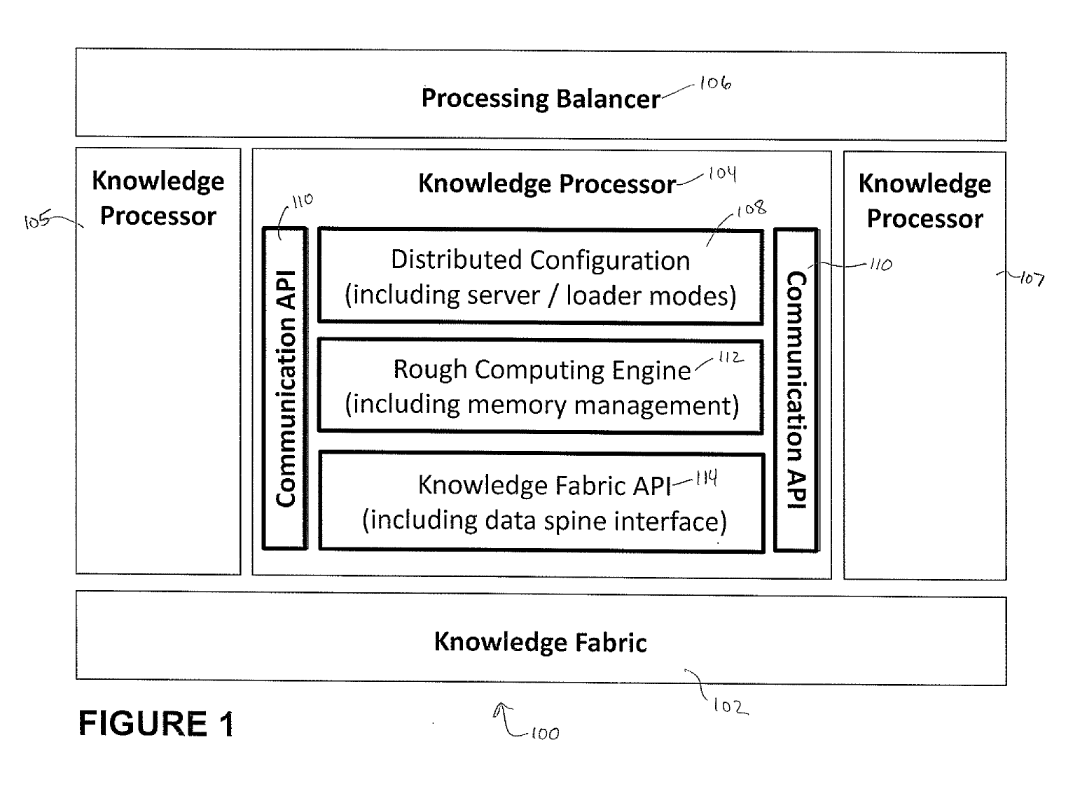

With reference to FIG. 1, in accordance with the present disclosure, an embodiment of a simple to use and deploy data fabric framework 100 that delivers fast ad-hoc investigative and predictive analytics and extensive data representation is shown. In the illustrated embodiment a knowledge fabric layer 102 is responsible for maintaining and providing meaningful information, as well as retrieving original data whenever required during computations. Basing on knowledge fabric 102, the described core analytical engine is capable of multiple query models, including approximate, exact and mixed modes of query execution.

The knowledge processor 104 is a basic entity resolving data queries received by the scalable knowledge system via a processing balancer 106. The three major components of the knowledge processor 104 are outlined below.

Distributed configuration 108 is responsible for connecting a given knowledge processor 104 to other entities in the system. It also specifies whether a given knowledge processor 104 works as a knowledge server, which is an entity responsible for assembling a result of a data query from partial results sent by other knowledge processors, or as a data loader. The data loader is an entity receiving a stream of external data to be loaded into the system, organizing such data into pluralities and querying such data in case it is necessary prior to sending it to other data locations linked to knowledge fabric 102. In some embodiments, distributed configuration 108 also includes parameters of behavior of a given knowledge processor 104 during query resolving, including thresholds for maximum amounts of data that a given knowledge processor 104 is allowed to retrieve. In some embodiments, distributed configuration 108 establishes a link between a given knowledge processor 104 and a particular remote data source. It should be noted that other knowledge processors, such as the depicted knowledge processor's 105, 107 include a similar architecture and communicate among themselves via the communication Application Programming Interface (API) 110.

Rough computing engine 112 is a core framework comprising algorithms working on summarized information about pluralities of data elements available through knowledge fabric 102. It is also responsible for managing recently retrieved pluralities of data elements and pieces of their descriptions in a memory of a given processing unit, so they can be accessed faster if needed while resolving next query or next operation within a given query. It is also responsible for selecting pluralities of data elements that need to be retrieved to accomplish operations.

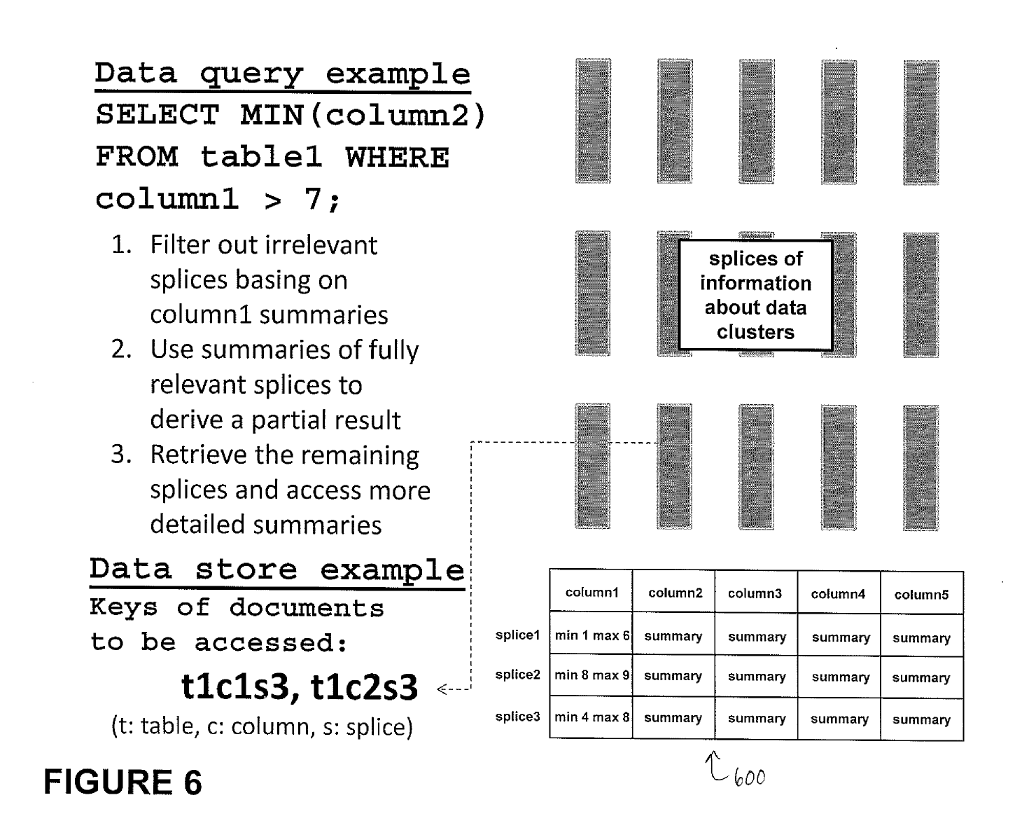

Knowledge fabric API 114 is responsible for accessing a repository of summaries that describe the actual raw data via predetermined statistical or other descriptive qualities. In some embodiments, such repository can include a database knowledge grid (e.g., as shown in FIG. 6) representing information stored locally by a given knowledge processor 104. In some embodiments, knowledge fabric 102 includes a grid of statistical summaries of the data and a grid of specifications how to retrieve particular pluralities of data elements from remote data locations or other knowledge processors. Knowledge fabric API 114 is an abstraction layer between a rough computing engine 112 and data sources. In an embodiment, the rough computing engine 112 does not need to be aware where and how particular pieces of data are maintained. This information is available within knowledge fabric 102 and it can be accessed via knowledge fabric API 114.

### Rough Computing Engine

In standard data processing environments, analytical DBMS systems are used as the means for collecting and storing data that are later utilized for the purposes of reporting, ad-hoc analytics, building predictive models, and so on, including as described in U.S. Pat. No. 8,838,593 to the present assignee, which is incorporated herein by reference in its entirety.

Embodiments of the present disclosure proceeds on this path by including the benefits of columnar architectures with utilization of a knowledge grid metadata layer aimed at limiting data accesses while resolving queries.

In an embodiment, the content of each data column is split onto collections of values of some consecutive rows. Each data pack created this way is represented by a rough value containing approximate summaries of data pack's content. Therefore, embodiments of the present disclosure operate either as a single-machine system with data stored locally within a simple file system structure, or as having a natural detachment of data content summaries that describe the data from the actual underlying data. The knowledge fabric layer 102 provides a shared knowledge about summaries and the underlying data, which can be stored in a number of distributed scenarios.

In an embodiment, rough values may contain a number of types of information about the contents of the corresponding data packs. They may be applied to categorize some data packs as not requiring access with respect to the query conditions. Rough values may also assist in resolving other parts of Structured Query Language (SQL) clauses, such as aggregations, different forms of joins, correlated subqueries and others, including assistance in completing the corresponding data operations in a distributed environment.

The most fundamental way of using rough values during query execution refers to classification of data packs into three categories analogous to positive, negative, and boundary regions in the theory of rough sets: Irrelevant (I) packs with no elements relevant for further execution; Relevant (R) packs with all elements relevant for further execution; and Suspect (S) packs that cannot be R/I-classified basing on available knowledge nodes.

In one case, rough values are used in order to eliminate the blocks that are for sure out of the scope of a given query. The second case occurs when it is enough to use a given block's summary. It may happen, e.g., when all rows in a block satisfy query conditions and, therefore, some of its rough values can represent its contribution into the final query result. More generally, one can say that it approximates information that is sufficient to finalize a given computation. Information is provided at both data pack content and data pack description levels. However, in order to deal with large data volumes, one embodiment assumes direct access only to that latter level.

In an embodiment, if the system had unlimited access to information at both levels, it would be theoretically able to work with a minimum subset of (meta)data entries required to resolve a query. However, it may work with iteratively refined approximation of that subset, which may be compared to some other ideas for mechanisms selecting minimum meaningful information out of large data repositories.

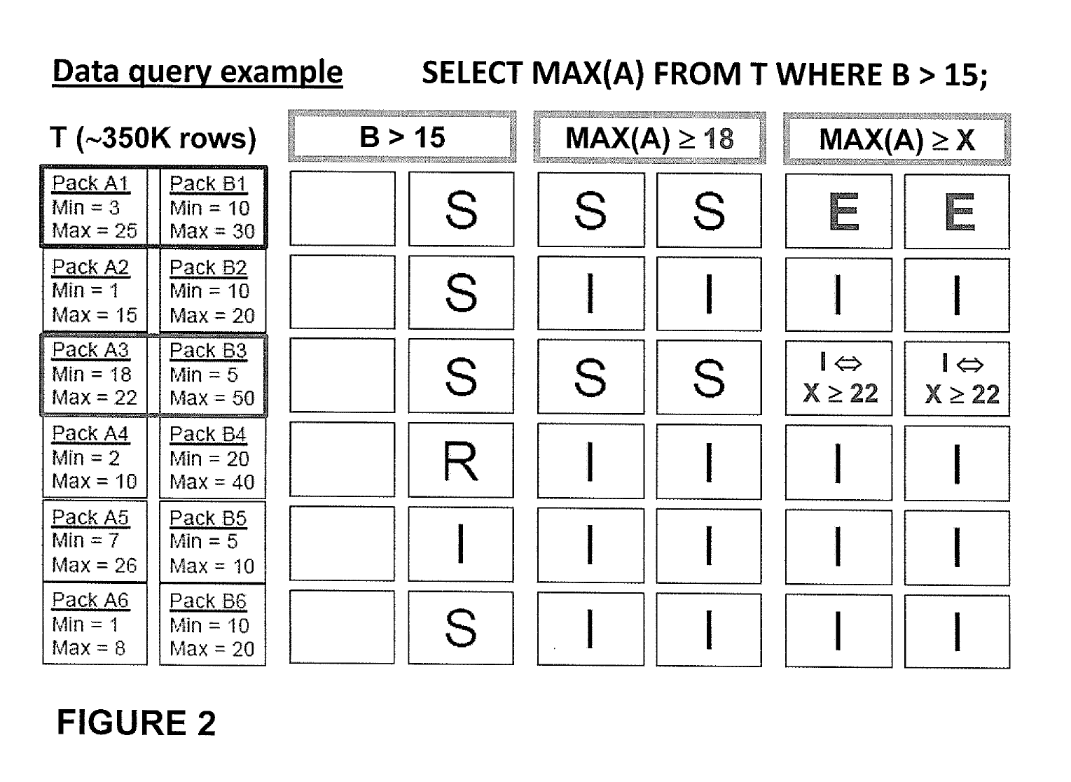

FIG. 2 is a diagram illustrating an example of a simple query involving two numeric attributes a and b in relatively small data table T. See, e.g., D. Slezak et al., “Two Database Related Interpretations of Rough Approximations: Data Organization and Query Execution,” Fundamenta lnformaticae 127, pp. 445-459, IOS Press (2013), which is incorporated herein by reference in its entirety for everything that it teaches. This example refers to a scenario where all pluralities of data elements are stored locally in a form of compressed data packs. However, in an embodiment, the rough computing engine 112 may be configured to work in an analogous manner to also retrieve data from other locations via the knowledge fabric discussed in this disclosure.

Minimum/maximum descriptions of data packs for a and b are presented at the left side of FIG. 2. For simplicity, we do not consider other types of summarized information and we assume no null values in T. However, an analogous example could be set up for a data table with null values included.

Since the data is stored in data packs, we do not need to access rough values and data packs of any other attributes. Thus, for the purposes of this particular data query example, we can assume that displayed clusters of rows, further referred as row packs, are limited to a and b.

Data packs are classified into three categories, denoted as R (relevant), I (irrelevant) and S (suspect). In the first stage of resolving the query, classification is performed with respect to condition b>15. The second stage employs rough values of row pack [A3,B3] to approximate final result as MAX(a)≧18. As a consequence, all row packs except [A1,B1] and [A3,B3] become irrelevant. At the third stage, approximation is changed to MAX(a)≧x, where x depends on the outcome of exact row-by-row computation (denoted by E) over the content of row pack [A1,B1]. If x≧22, i.e., if row pack [A1,B1] turns out to contain at least one row with values satisfying conditions b>15 and a≧22, then there is no need to access row pack [A3,B3].

### Approximate Querying

The simple case study displayed in FIG. 2 is an example of iterative refinements of data pack classifications. Moreover, rough values are applied here to optimize decompression ordering, by following a kind of expected information gain related to accessing particular packs. Last but not least, this example shows a natural ability to produce query result approximations. As illustration, let us note that rough values in FIG. 2 provide more information than just MAX(a)≧18. Given irrelevance of row pack [A5,B5], we know that MAX(a) must fall into interval [18,25]. This interval can be gradually narrowed down by accessing some of data packs or, in an embodiment involving remote or distributed maintenance of data, retrieving some of suspect pluralities of data elements using information accessible in knowledge fabric 102.

One beneficial direction in the area of SQL approximations related to the enhancements disclosed herein refers to controlling a complex query execution over time by way of converging outcome approximations. Such a convergence can take different forms, e.g.: monitoring partial query results until the calculation is completely finished, with possibility to stop it at any moment in time, or pre-defining some execution time and/or resource constraints that, when reached, will automatically stop further process even if the given query results are still inaccurate.

Every SELECT statement returns a set of tuples labeled with the values of some attributes corresponding to the items after select. Approximation of a query answer can be specified as a summary describing attributes of such a tabular outcome. Furthermore, results of SELECT statements can be described by multiple ranges, as if an information system corresponding to a query result was clustered and each cluster was described by its own rough values. In an embodiment, the objects that we want to cluster are not physically given. Instead, they are dynamically derived as results of some data computations, related in this particular case to SQL operations. In some applications, where outcomes of SELECT statements contain huge amounts of tuples, reporting a grid of summarized information about particular clusters of resulting tuples may let for better visual understanding of computations. In an embodiment, it may be useful to compute descriptions of such clusters of resulting tuples with no need of explicit derivation of all those tuples. For the purposes of the presented scalable knowledge framework, it is especially important to extend such methods onto results of intermediate computations leading toward final result of a data query. By structuring such intermediate results as collections of pluralities of data elements described by their statistical summaries and pointers letting next computations to retrieve them, we achieve a unified knowledge fabric framework for managing both input data and dynamically derived data.

In an embodiment, a randomized intelligent sampling technique can be used to select pluralities of data elements providing sufficient information for accomplishing a given operation with sufficient degree of accuracy. Knowledge fabric of the present disclosure can assist in selecting pluralities of data elements that are most representative for the larger data area by means of their summary range intersections with summaries of other pluralities. In fact, if a given plurality of data elements is expected to have many similar elements to other pluralities basing on its summarized information, it is likely to provide a good sample component for computations.

For the presented methods, it is important to handle scenarios wherein a given plurality of data elements has been modified by a remote data system or an independent data organization process and, therefore, it is not correctly described by summarized information available in knowledge fabric. For the purpose of building a scalable analytical solution over large, complex, and dynamically changing data environment, it is impossible to guarantee that statistical summaries are always correct.

In one embodiment, if a given plurality of data elements is selected to be retrieved by the rough computing engine 112, its detailed processing can lead to an amendment of summarized information stored in knowledge fabric 102. However, there may be also cases when rough computing engine 112 does not select a given plurality of data elements because of outdated summarized information and, if the given plurality was selected, it would lead to more accurate result of a data query. Therefore, in some embodiments, rough computing engine 112 may request for retrieving a plurality of data elements even if it seems not necessary based on computations with summaries, if the system anticipates that a given summary might be outdated.

In one embodiment, rough computing engine 112 may not retrieve a given plurality of elements even though it is necessary to finalize computations. This may happen if a remote data store from where the given plurality needs to be retrieved is currently unavailable, the given plurality was removed by an independent process, or there is an additional time constraint for resolving a data query and retrieving a given plurality of data elements is anticipated to be too costly. In such cases, an intelligent randomized method for simulating a content of a given plurality of data elements can be applied and rough computing engine 112 can continue with further operations as if it retrieved the actual plurality.

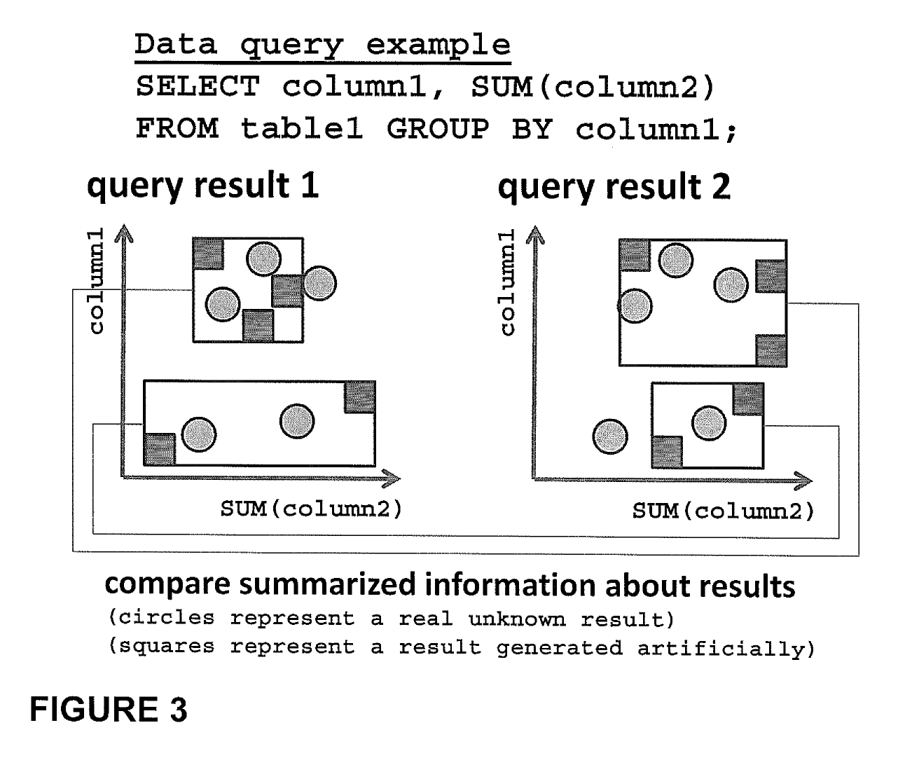

FIG. 3 illustrates an example of an embodiment wherein operation of randomized simulation of a content of such missing pluralities of data elements is repeated at least two times and results of two independent runs of execution of the same data query are compared. For data queries with large numbers of resulting tuples it may be difficult to compare such outcomes directly. In one embodiment, the previously mentioned method of clustering obtained results is applied, wherein both results are transformed to a group of pluralities of new data elements described by statistical summaries and a comparison of summaries of both results is used to heuristically express a degree of accuracy of the obtained outcome with respect to an outcome of data query that might be achieved if all necessary pluralities of data elements were successfully retrieved via the knowledge fabric 102.

### Distributed Processing

There are a number of approaches based on both standard and iterative strategies of decomposing and merging computational tasks. There are also a number of approaches to distributed data processing, including (No)SQL databases and their analogies to MapReduce paradigms.

In general, any iterative extensions of classical MapReduce framework may be applicable from the perspective of disclosed model of computations. On top of that, the analysis of statistical summaries and iterative data retrieval during the process of query execution can eliminate unnecessary computational tasks, which is especially important for multi-user scenarios.

Data processing in distributed and dynamic environments can be also considered from the perspective of approximate querying. From the present view, it is worth referring to models supporting exchanging summaries instead of data, enabling to trade query delays for accuracy, incrementally returning results as remote data systems become available. This is especially important in a distributed processing environment, assuming exchange of information between herein disclosed knowledge processors at a level of summaries of partial results instead of detailed pluralities of new data elements representing partial results.

For illustrative purposes, consider one of the most common types of analytical queries, which are so called aggregations. For groups of rows defined by so called aggregating (or grouping) columns there are computed aggregation functions over aggregated (or grouped) columns.

There are various strategies of computing aggregations. For example, one may think about data compression and column scans aimed at acceleration of data access and processing in columnar databases. In one embodiment, rough computing engine can work with a dynamically created hash table, where one entry corresponds to one group. When a new row is analyzed during a data scan, it is matched against tuples in the hash table. If a given group already exists, then appropriate aggregations are updated. Otherwise, a new group is added to the hash table and initial values of aggregation functions for this group are specified. Thus, the size of hash table depends on the number of different values of an aggregating column occurring in data subject to filtering conditions.

In another embodiment, one can schedule jobs operating on disjoint sets of rows and, if they include rows corresponding to any common groups, do a result merge after all jobs are finished. One can utilize summarized information about pluralities of data elements relevant for a given aggregation query in order to intelligently plan how to decompose aggregation with respect to input pluralities and output groups, so the effort to be spent on merging partial results is minimized.

In multi-machine environment, one of possible realizations of decomposed aggregating is to consider one selected knowledge processor as so called master, which can use other knowledge processors (workers) to compute dedicated jobs. The master is responsible for defining and dispatching jobs, as well as collecting and assembling partial results. Jobs can be defined with respect to both subsets of input pluralities of data elements and subsets of output groups. The key observation is that the master can specify jobs using summarized information available in knowledge fabric and then specify the tasks via communication API, so other knowledge processors know which pieces of knowledge should be accessed.

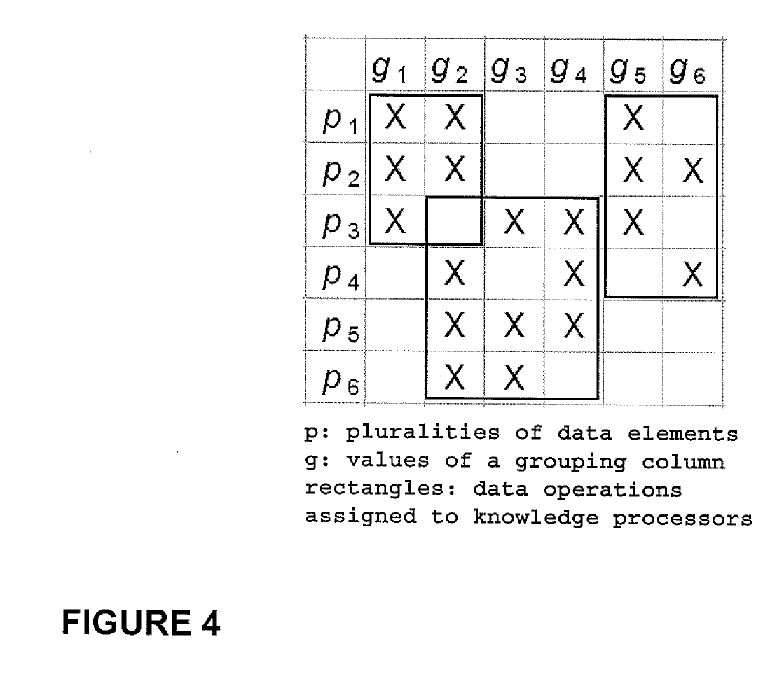

FIG. 4 is a diagram illustrating an embodiment of a design of distribution of aggregation query onto three knowledge processors. A master knowledge processor can select one of the jobs for itself. In this example, the master knowledge processor retrieves the three first pluralities of data elements and computes aggregation results for the two first resulting tuples labeled by values of the grouping column. In practice, for large amounts of such values, the clusters of output tuples should be considered. The two remaining tasks can be assigned to two other knowledge processors. After resolving partial results, knowledge processors can first exchange summarized information and then proceed with assembling the final result.

### Data and Knowledge

In order to conduct analytics, one should gather knowledge about data. Such knowledge may refer to location and format of particular data pieces, as it is useful in order to optimize mechanisms of data accessing. It can also refer to data regularities or, as introduced before, approximate summaries which may assist in planning analytical operations. In general, a layer responsible for acquiring necessary aspects of data needs to be flexible and easily reconfigurable, so it reflects both the nature of data and expectations of users. This is why, rather than operating directly on relevant data sets, some embodiments of the present disclosure operate at a more granular level of representation.

It is important to remember that data sets are often decomposed from the very beginning, prior to their loading into a data processing system. In an embodiment, the present system is able to selectively and intelligently configure the data network to load and convert the data that is being analyzed, or to leave it at the source, and periodically synch the metadata required to query that data. This is done to ease the burden of ETL systems, and to provide a much more effective and agile data platform. It also acknowledges one of the most important components of scalable knowledge—the ability to elegantly handle the approximate nature of large data sets.

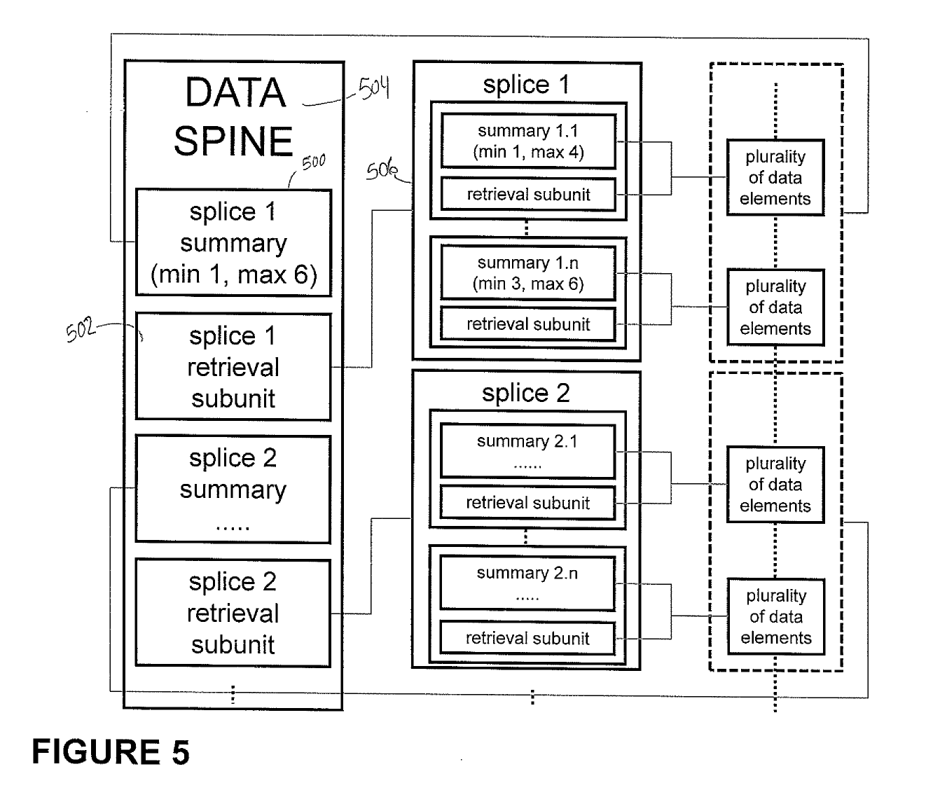

FIG. 5 is a diagram illustrating a structure for maintaining information about data in the knowledge fabric 102. In one embodiment, each plurality of data elements that can be queried against within the presented scalable knowledge framework is represented in knowledge fabric 102 by an information unit, which contains one or more summary subunits 500 and corresponding retrieval subunits 502. Summary subunit 500 contains statistical information about a given plurality of data elements, which can be used, as described before, by rough computing engines embedded into knowledge processors communicating with knowledge fabric. Thus, a rough computing engine looks at a given plurality of data elements though the glasses of statistical information, even if the plurality itself is not physically present within the framework. Retrieval subunit 504 is not directly visible to a rough computing engine. It includes an instruction how to provide a given plurality of data elements to the rough computing engine, whenever necessary and whenever technically possible. Below we enumerate some non-limiting examples of how pluralities of data elements can be stored and how the corresponding retrieval subunits are configured.

In one embodiment, a plurality of data elements can be stored in a distributed file system. For example, in one or more files, possible in a compressed form, and possibly together with some other pluralities of data storage types. In this case, the retrieval subunit 502 of the information unit 502, 504 describing this plurality of data elements in knowledge fabric specifies a directory of the file and a location of the plurality of data elements in the file.

In another embodiment, a plurality of data elements can be stored in a key-value store, as a value in a key-value pair. In this case, the retrieval subunit 502 of the corresponding information unit specifies the key of the key-value pair, so it is possible to quickly search and retrieve the plurality of data elements from the store.

In another embodiment, a plurality of data elements can be stored in a data system which is at least one of a relational database system, a statistical data analysis platform, or a document store. This case is analogous to embedding Extract, Transform, Load (ETL) methods into knowledge fabric. However, the exact results of ETL do not need to be stored in the system. The system can only store statistical information about those results and reconstruct them again, possibly over a data source which has been changed in the meantime, whenever requested by one of rough computing engines. In this case, the retrieval subunit of the first information unit specifies a method of acquiring the plurality of data elements as a result of at least one of a SQL statement, a statistical operation, or a text search query. Once a procedure of defining such queries or operations is design for a remote data source, it becomes linked to a general data platform that knowledge processors can work with.

In one embodiment, as illustrated by FIG. 5, information units describing single pluralities of data elements can be grouped into splices corresponding to larger collections of data elements. It constitutes a data spine 504, which may be easily uploaded and updated via knowledge fabric API, as a starting point for each of knowledge processors to work with knowledge fabric.

In one embodiment, each plurality of data elements contains 64K of data elements, and each splice contains information how to handle 1K of pluralities. Thus, retrieval subunit 502 of splice 1 in FIG. 5 gives information how rough computing engine can upload information about 1K of pluralities 506, wherein information comprises statistical summaries of particular pluralities within the splice, and specifications how to retrieve particular pluralities from their locations. The splice does not contain real data but it contains information how to access real data and it enables to work with finer statistical summaries.

Splices can be treated by knowledge processors as pluralities of complex data elements, where each of data elements turns out to be an information unit describing a smaller plurality of data elements. Summary subunit 500 of splice 1 in FIG. 5 contains the same type of information as more detailed summaries but now this information refers to a bigger cluster of data elements (for example 64K×1K of data elements).

In one embodiment, splices can be stored within files in a file system. In another embodiment, they can be stored in a document store. A content of a given splice is stored in a document. Document's metadata includes summary subunit describing the whole cluster of the corresponding data elements. The key of the document in the document store encodes a context of using the first plurality of information units by the data processing system.

In one embodiment, data queries received by the presented system can be specified against a relational data model, wherein each splice represents values of tuples in a cluster of tuples over a column in a table in the relational data model and the key of the document storing this splice in the document store encodes an identifier of the table, an identifier of the column, and an identifier of the cluster of tuples.

FIG. 6 is a diagram illustrating an embodiment mapping of the keys onto a relational data model, so it is easy to search for splices required by a rough computing engine. It also shows that rough computing engine can work with summary subunits corresponding to particular splices just like in more standard deployments described in previous sections.

In an embodiment, knowledge fabric can manage all above objects for synchronization, high availability, and other scalability features. The presented framework can be also regarded as a step toward relaxing data consistency assumptions and letting data be loaded and stored in distributed way (including the third party storage platforms), with no immediate guarantee in an embodiment the engine operates with completely refreshed (on commit) information at the level of data and statistics. This ability fits real life applications related to processing high volumes of dynamic data, which are often addressed by search engines, where complete accuracy of query results is not required (and often unnecessary or even unrealistic from practical point of view). It can also provide faster data load.

In particular, as shown in the example of FIG. 6, a certain data query condition is resolved by the knowledge processor 104 by filtering out irrelevant splices based on summaries in the knowledge grid 600 that do not correspond to the query condition. Summaries of fully relevant splices are used to derive a partial query result. Finally, the knowledge processor 104 retrieves remaining splices and accesses additional summaries to resolve the query. In the illustrated example of FIG. 6, the query is resolved into keys of documents to be accessed, where such keys are in a table, column, splice format.

Data Load and Organization

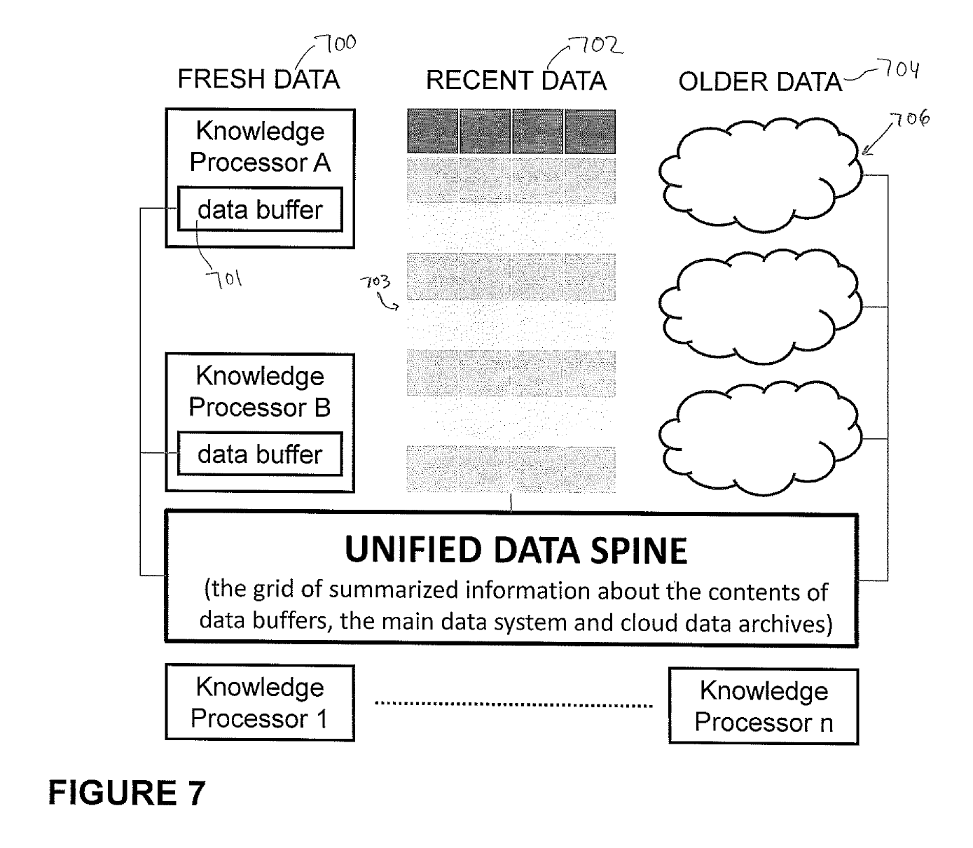

The methods presented in the previous section for storing information about data within knowledge fabric can be used in many configurations. FIG. 7 is a diagram illustrating one of important practical scenario, where all data are physically loaded to the scalable knowledge system, but within the system they are managed differently. Freshest data 700 are buffered in memory 701 of knowledge processors configured as data loaders. Recent data 702 is stored in a “classical” way, that is, pluralities of data elements are physically stored on disk 703. Finally, pluralities of data elements corresponding to historical or older data 704 are sent to a cloud 706. But from the perspective of knowledge processors responsible for query resolving all those pieces of data are visible in the same way via their statistical summaries. Additionally, knowledge processors A and B in FIG. 7 have faster access to their data buffers, so it can be taken into account when planning an execution of a data query. Performance may depend on the quality of rough values and the algorithms that use them. It is worth adding that in an embodiment, the system may assign rough values not only to physical data packs but also to intermediate structures generated during the query execution (e.g., hash tables used in aggregations). Also, in an embodiment the system may dynamically produce rough values applicable at further execution stages. In an embodiment, the system may also create rough values for different organizations of the same data or keep rough values for already non-existing or even never fully acquired data, especially if some corresponding operations require only approximate information represented in form of rough values.

There are various strategies of partitioning incoming rows into pluralities of rows, further decomposed into pluralities of data elements. In an embodiment related to the general area of data processing and mining, this task is referred to as to data granulation. In an embodiment the system may need to analyze large amounts of data being loaded in nearly real time. In such situations such granulation needs to be very fast, possibly guided by some optimized criteria but utilized rather heuristically. While loading data, one may control the amounts of values stored in data packs. To a certain extent, one may slightly influence the ordering of rows for the purposes of producing better-compressed data packs described by more meaningful rough values, following analogies to data stream clustering. In an embodiment, loading process can be distributed, resulting in separate hubs storing data. Each of such hubs can be optimized with respect to other settings of data stream clustering or data pack volume parameters.

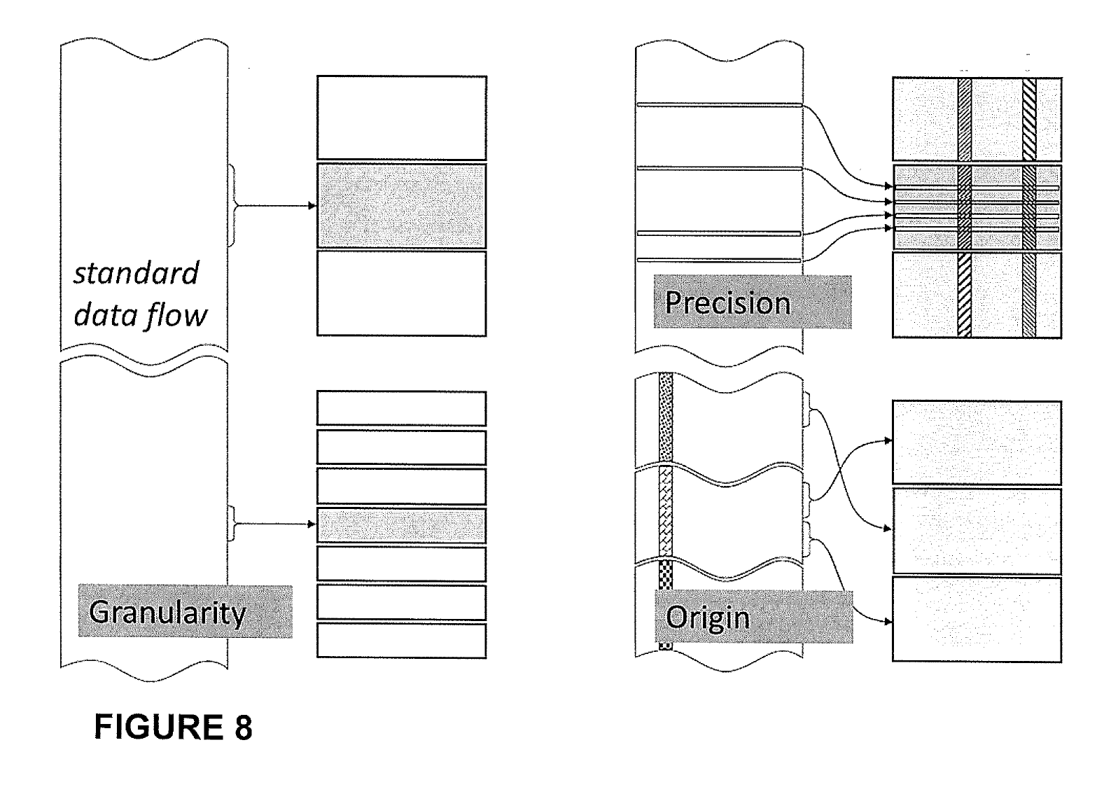

FIG. 8 is a diagram that summarizes the above parameters responsible for organization of the incoming data. From the perspective of the presented scalable knowledge framework, it is important to realize that the same methods can be used also for moving data between data stages. For example, in one embodiment, an external monitoring system can decide that some piece of one of data buffers in FIG. 7 should be moved to the recent data store. Such piece can be prepared according to different parameters, which can be a part of distributed configuration of a knowledge processor as well. Furthermore, after some time, the same monitoring system can decide to reorganize some piece of recent data and move it to a “private cloud” storing historical data. Additionally, for methods of how to heuristically change the ordering of rows while loading them into the system, see U.S. Pat. No. 8,266,147 to the present assignee, which is incorporated herein by reference in its entirety.

In some embodiments, it is also useful to look at the data flow depicted at FIG. 8 as a result of some intermediate data operation, which should be further used to compute the final query result. Such intermediate result can be organized into pluralities of new data elements as well. Statistical summaries of describing the pieces of intermediate data operation can be then sent to other knowledge processors responsible for other data operations.

In an embodiment this leads to a model where data is loaded remotely to many locations but the main server (or servers)—called a knowledge server—gets information about new data only from time to time, via refreshing knowledge fabric. Knowledge server is capable of accepting and running user queries. It may be a separate mirrored machine, or each local server can be extended to become a global server so the machines are fully symmetrical. Data loaders form data packs and they are configured to send the data packs to local servers—knowledge processors. A single data pack can be sent to multiple processors in order to achieve redundancy and wider query optimization opportunities. The algorithm which data pack should go to which knowledge processor may vary. In an embodiment it may be round robin, it may be clustering, it may be range partitioning, it may be based on similarity to other data packs stored in particular locations with respect to rough value and query workload characteristics, and so on. As noted previously, in an embodiment there may be various types and components of rough values. Rough values which are relatively bigger in size and more sensitive to data changes can be located in particular knowledge processors, closer to the data storage or, more generally, data storage interface level. Smaller, more flexible types of rough values, possibly describing wider areas of data than single data packs, can be synchronized—with some delays—at a global level of knowledge servers in order to let them plan general execution strategies for particular data operations.

### Knowledge Processors

It has been discussed how to create knowledge fabric maintaining a kind of spine of approximate summaries of data loaded into an embodiment of the present system in a distributed way. In an embodiment, rough values can be computed and efficiently used also for intermediate results and structures created during query execution, such as e.g. hash tables storing partial outputs of joins and aggregations. Regardless of whether the data is stored in a single place or in a distributed way, rough values can be also used to specify optimal sub-tasks that can be resolved concurrently at a given stage of computations. Therefore, in an embodiment various levels of rough values can constitute a unified layer of communication embedded into knowledge fabric for flexible distributed data processing.

Knowledge processors may be responsible for storing and using data in various forms. In an embodiment the aggregate of knowledge processors and the resulting summaries is a scalable knowledge cluster which users can easily run predictive and investigative analytics against.

From this perspective, FIG. 7 depicts architectural realization of an embodiment of the present disclosure. It assumes there is a layer of local knowledge processors that are capable of buffering data and executing query operations locally. On top of this, there is also a layer of knowledge processors configured to work against a unified knowledge fabric. In particular, they have an access to summaries of data buffers, although those summaries may describe a current content of data buffers only with some limited accuracy. Therefore, it is better to configure local knowledge processors to work with buffered data and to exchange summaries of results of local operations with other knowledge processors, whenever needed while resolving complex data queries. As in the previously considered examples of using rough computing engines, other knowledge processors need to ask for detailed partial results only if their summaries are insufficient to accomplish further operations with a specified degree of accuracy.

In an embodiment the general scheme of query execution looks as follows. A query is assigned to one of knowledge processors via processing balancer. Knowledge processors responsible for data query resolution should use their knowledge server configuration while communicating with other knowledge processors via communication API (see FIG. 1). The data query is executed in typical phases, just like in case of standard solutions and other SQL-oriented DBMS systems. At each phase, the knowledge server uses data location information represented by retrieval subunits of information units stored in knowledge fabric to choose which knowledge processor should perform an operation on which pluralities of data elements, so all pluralities are covered with some load balancing. Requests to particular knowledge processors, in an embodiment, can be formulated not only in a language of pluralities of data elements, but also in a language of value ranges or other data constraints (compare with FIG. 4). The requested operations, along with information on which areas of data should be executed, are sent to knowledge processors.

In an embodiment, the results from a knowledge processor are sent back to the knowledge server. Their form can be various—actual values, compressed data packs, data samples, bit filters, and so on. An important opportunity is to send only rough values of obtained partial results. In such a case, detailed results can be optionally stored or cached on knowledge processors if there is a chance to use them in further steps of query processing. Also, in an embodiment, rough values sent to the knowledge server may be utilized to simulate artificial data samples that may be further employed in approximate querying or simply transferred to some third party tools. All those methods are based on the same principles of rough sets and granular computing as outlined in the previous sections, but now within a fully scalable framework of knowledge processors working with knowledge fabric and communicating with each other via API.

In an embodiment, the knowledge processor configured as a knowledge server for purposes of data query resolution combines the partial results and starts the next query phase.

In an embodiment, a knowledge processor may work with locally stored data. In an embodiment, joins and operations after joins can require access to data stored on different locations. Additionally, there can be a threshold defined how many copies/storage occupation the system can afford.

### Processing Configurations

In some embodiments, there may be a lot of data and the question is whether it is all needed. Therefore, the present embodiment should address three scenarios which may be mixed together in some specific cases: Direct access to data, data regeneration, and no data at all. This is the reason that exact and non-exact computational components need to co-exist. Moreover, it is important to leverage domain knowledge about usefulness of such components.

The present embodiment leads to a framework where approximate computations assist execution of both standard and novel types of operations over massive data. In particular, in databases, it can be utilized to support both classical SQL statements and their approximate generalizations.

In an embodiment, an API with data operations, such as sort, join, or aggregate may be used as well, with no need of integrating with SQL-related interfaces. In an embodiment, is important to prepare an API that includes both exact and approximate modes of operations within a conveniently unified framework. In an embodiment, appropriate analytical API may also provide convenient means for visualization of summaries of query results.

Ability to approximate is important. Often there is no easy way to get exact answers for aggregate queries (e.g., queries that summarize counts or summations of things). In an embodiment, scalable knowledge gives users a number of seamless query models that allow introspection of the data and alternation between approximation and exactness in an easy way. In an embodiment, the important component of the query models is that they are context specific. The disclosure in an embodiment, needs to provide a user a way to choose and control the way of executing queries in a form of different types of data source and query result approximations.

In an embodiment, integration of knowledge fabric querying with intelligently chosen pluralities of data elements in order to make better approximations on high speed (e.g. based only on data present in memory or data anticipated to be most representative for a query) is disclosed.

The main inspiration for an embodiment for query approximations is to speed up execution and/or decrease a size of standard SQL outcomes by answering with not fully accurate/complete results. In some embodiments, the accurate query results may not be obtained or they may be achievable with a delay which is not related only to the computational cost of applied data processing algorithms. In an embodiment involving distributed and remote data, the need of approximations is even bigger. One can list a number of cases, where approximation of query results can be achieved faster and it may be considered as more reliable in distributed environments.

For both final query results formulated in a granular fashion and partial intermediate results being sent among knowledge processors, an embodiment adopts on-load data clustering aiming at improving precision of rough values to the case of generation of most precise and most meaningful rough values describing data operation outcomes. Additionally, in an embodiment, the present system produces such outcome rough values with minimized cost of access (or no access at all) to pluralities of tuples described by those rough values, as well as minimized need to generate classical query answers prior to their summarized description.

In general, the embodiment may implement a number of techniques utilizing rough values at particular stages of execution of SELECT statements, assuming that an access to summarized information available in knowledge fabric is more efficient than retrieving the underlying pluralities of data elements. All of them may be based on heuristics analogous to the mechanisms of dynamic approximation of standard query outcomes. Approximations are often not perfectly precise but can be obtained very fast. Furthermore, in a distributed environment, as disclosed herein, the strategy can be modified by allowing a knowledge processor responsible for given data operation to use its own data with no limitations but restrict it from too intensive requests for additional data from other processors. In an embodiment, integration of information available in knowledge fabric with such data may significantly improve the precision of the results. In an embodiment, rough value information combined with location of data packs at particular nodes can highly influence the strategy of allocating data to operations designed for particular knowledge processors. In that case, besides minimization of a need of sending data between processors, the optimization goals are related to minimization of the cost of aggregating partial results. For example, in an embodiment, given a GROUP BY statement to be executed over a distributed store of partially duplicated data, the system may use knowledge fabric to specify a subset of data that should be processed by each of processors in order to optimize both above aspects. Going further, in an embodiment, communication between knowledge processors can be designed at a level of rough values, so data maintained locally at a given knowledge processor are analyzed against summaries or dynamically generated samples representing resources of other processors.

In another embodiment, an end user provides an upper bound for query processing time and acceptable nature of answers (partial or approximate). One skilled in the art can understand an analogous framework designed for an embodiment, wherein a query is executed starting with summarized information and then it is gradually refined by retrieving heuristically selected pieces of data. The execution process can be then bounded by means of various parameters, such as time, acceptable errors, or percentage of data retrieved. The disclosed scenarios lead toward a framework of contextual query where users (or third party solutions) dynamically specify parameters of query execution and query outcome accuracy. In an embodiment, domain knowledge is utilized to control the flow of incoming data, internal computations and result representation, where it is important to investigate models for representing only the most meaningful information which is especially difficult for complex data.

In another embodiment, one should realize what accessing data content may mean in a distributed data environment, where particular parts of data may be temporarily inaccessible or a cost of accessing them is too high, suggesting working only with their approximate summaries or, optionally, their simulation derived from those summaries. In a particular embodiment, rough values for different organizations of the same data may be created or rough values can be kept for already non-existing or even never fully acquired data, especially if some corresponding operations require only approximate information represented in form of rough values or artificial data samples generated subject to constraints specified by rough values. Therefore, contextual processing does not refer only to the querying strategies. It refers to politics of managing different pieces of a data model, where some data areas and processing nodes may be equipped with more fine grained historical data information than others.

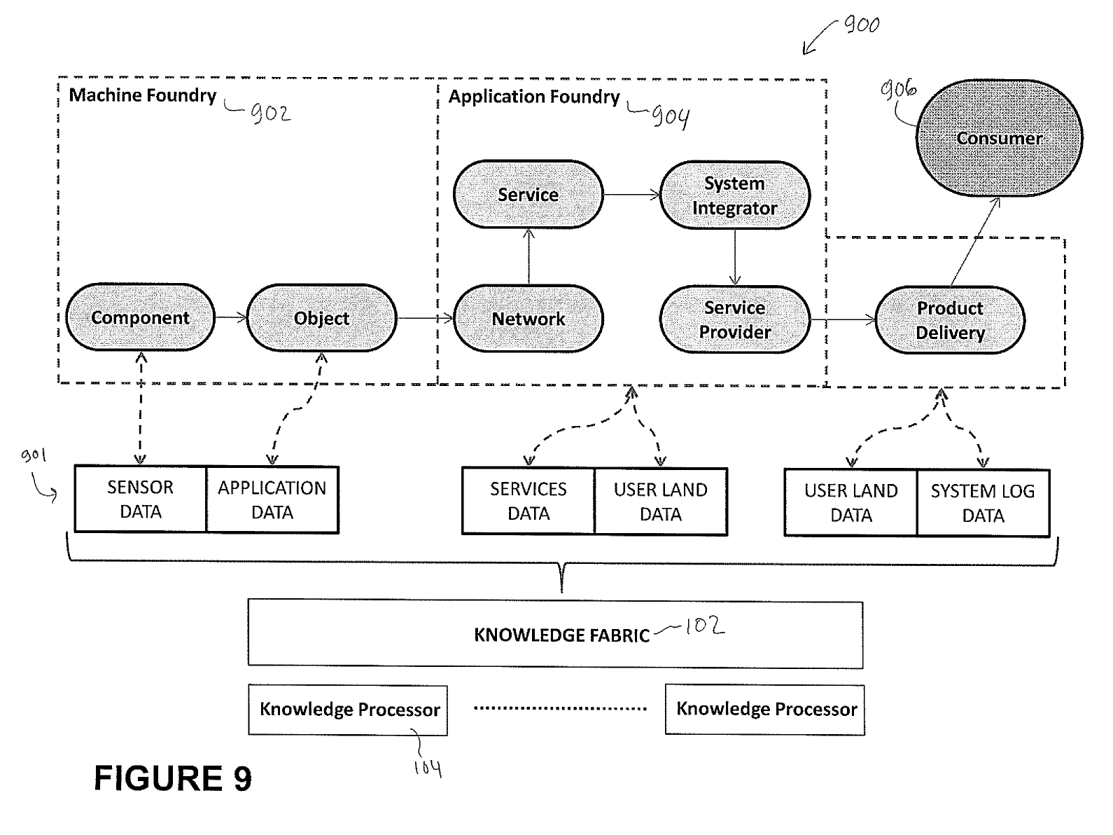

FIG. 9 is a diagram of an exemplary system environment where data 901 is stored in different data store locations of a large application or sub-system 900. Such data may be stored across the machine foundry 902, application foundry 904, and/or consumer or user side 906. In the illustrated embodiment, data queries may be specified against particular sources or join some sources as if they were in the same data system.

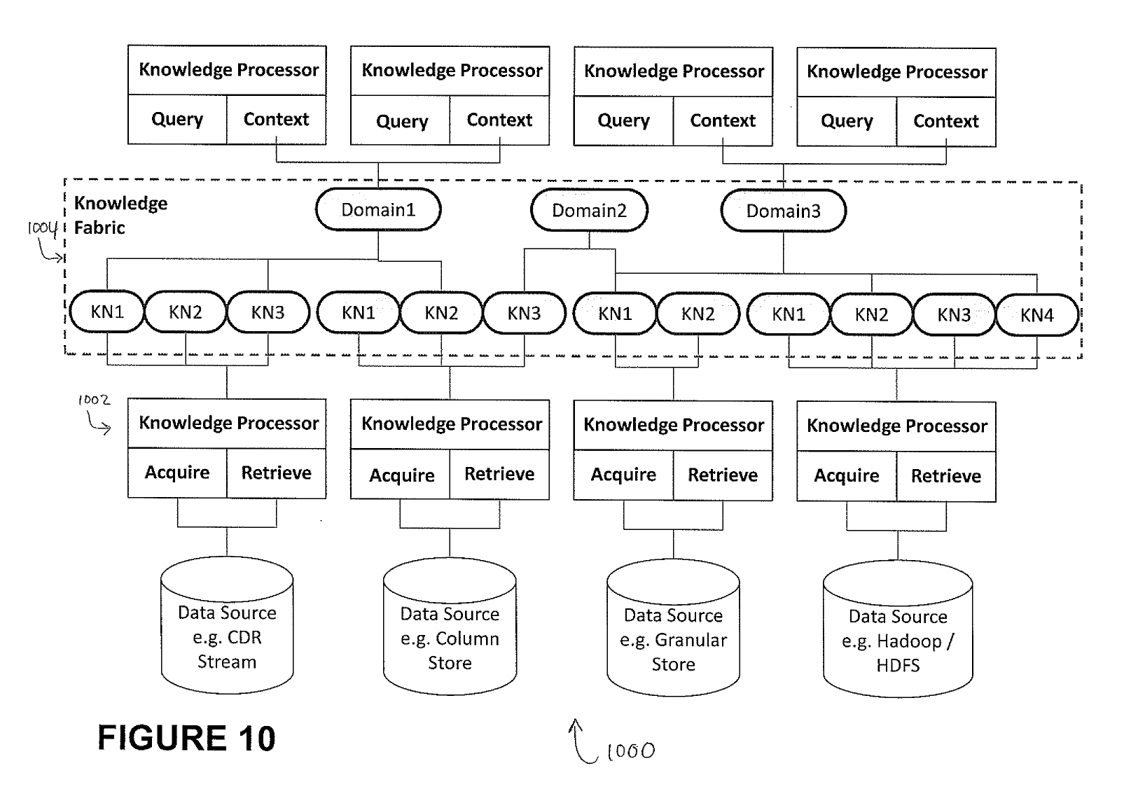

FIG. 10 is a diagram illustrating an embodiment of a system 1000 where different knowledge processors work in different modes as discussed above. In the illustrated embodiment KN represents a knowledge node—it embraces all splices representing an information about a given column in a given relational data table. FIG. 10 illustrates that some of the knowledge processors 1002 may be responsible for retrieving/loading information from particular data sources (for instance, a link between a knowledge processor and a particular data source can be a part of Distributed Configuration as well). Knowledge Processors 102 can still resolve queries or some parts of queries (especially if most recently acquired information is to be involved) but they will not be responsible for assembling final results of queries. Other knowledge processors among the plurality of processors 1002 can fully focus on querying against the knowledge fabric 1004. In an embodiment, the knowledge processors 1002 can be additionally configured. They may work in a context of a particular domain (e.g., a type of user, a type of query), which may influence with which types of information the processors 1002 work, as there may be different types of statistical summaries, and whether, for example, they are configured to resolve approximate results or rather need to report exact results of received queries.

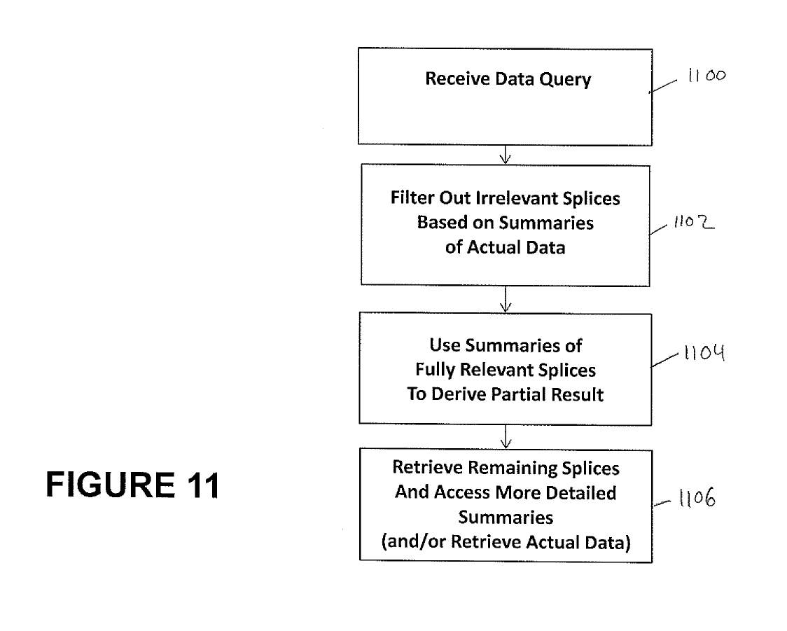

FIG. 11 is a flow chart illustrating an embodiment of a method for query result determination by the knowledge processor of FIG. 1. In step 1100, the knowledge processor 104 receives a data query, such as that depicted in FIG. 6 above. In step 1102, the knowledge processor 104 examines summaries of data, for example by determining whether statistical data descriptions satisfy one or more query conditions, and filters out irrelevant splices of data. In step 1104, the knowledge processor 104 uses the examined data summaries of fully relevant splices to derive at least a partial query result. Notably, this avoids the need to access actual stored data among various data sources and significantly speeds up processing. If the derived result is a partial result, in step 1106, the knowledge processor retrieves remaining splices to access more detailed data summaries (e.g., in a configuration similar to that of FIG. 5 above) and/or retrieves actual data (e.g., when a query condition cannot be satisfied by examining a data summary).

Unless specifically stated otherwise as apparent from the following discussion, it is appreciated that throughout the description, discussions utilizing terms such as “processing,” “computing,” “transmitting,” “receiving,” “determining,” “displaying,” “identifying,” “presenting,” “establishing,” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices. The system or portions thereof may be installed on an electronic device.

The exemplary embodiments can relate to an apparatus for performing one or more of the functions described herein. This apparatus may be specially constructed for the required purposes and/or be selectively activated or reconfigured by computer executable instructions stored in non-transitory computer memory medium.

It is to be appreciated that the various components of the technology can be located at distant portions of a distributed network and/or the Internet, or within a dedicated secured, unsecured, addressed/encoded and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying and/or communicating data to and from the connected elements. The term “module” as used herein can refer to any known or later developed hardware, software, firmware, or combination thereof that is capable of performing the functionality associated with that element.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Presently preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of resolving data queries in a data processing system, the method comprising:
receiving in the data processing system a data query, wherein the data processing system stores a plurality of information units describing pluralities of data elements, a first information unit having a retrieval subunit that includes information for retrieving all unique data elements in a first plurality of data elements and a summary subunit including summarized information about data elements in the first plurality of data elements;
deriving via the data processing system a result of the data query, wherein the result of the data query comprises a plurality of new data elements, and wherein the data processing system uses
summary subunits of information units to select a set of information units describing data elements that are sufficient to resolve the data query,
retrieval subunits of information units in the selected set of information units to retrieve data elements sufficient to resolve the data query, and
retrieved data elements and summary subunits of information units stored by the data processing system to resolve the data query; and
returning the result of the data query.

2. The method according to claim 1, wherein the first information unit includes a plurality of summary subunits and a plurality of retrieval subunits, wherein the data processing system chooses a first summary subunit of the first information unit and a first retrieval subunit of the first information unit to be used while resolving the data query according to at least one of a predefined scenario of a usage of the data processing system and an interaction with a user of the data processing system via an interface.

3. The method according to claim 1, wherein the first information unit does not belong to the set of information units selected as describing data elements that are sufficient to resolve the data query, and wherein the first plurality of data elements is retrieved to be used while resolving the data query resulting from at least one of an interaction with a user of the data processing system via an interface, and a likelihood that the summary subunit of the first information unit is inconsistent with the first plurality of data elements.

4. The method according to claim 1, wherein the first information unit belongs to the set of information units selected as describing data elements that are sufficient to resolve the data query, and wherein the first plurality of data elements is not retrieved as a result of at least one of an interaction with a user of the data processing system via an interface, and a constraint for a maximum allowed amount of data elements that can be retrieved while resolving the data query, the method further comprising:
heuristically creating two pluralities of artificial data elements, wherein both created pluralities are consistent with the summary subunit of the first information unit;
deriving two artificial results of the data query, wherein a first artificial result is obtained by using a first plurality of artificial data elements and a second artificial result is obtained by using a second plurality of artificial data elements;
creating two new information units describing artificial results of the data query, wherein the summary subunit of a first new information unit includes a summarized information about the first artificial result and the summary subunit of a second new information unit includes a summarized information about the second artificial result;
returning the first artificial result as the result of the data query with an additional information about its accuracy, wherein the accuracy of the result is heuristically measured based on a degree of similarity between the summarized information about the first artificial result and the summarized information about the second artificial result.

5. The method according to claim 1, the data processing system further connected to a plurality of data systems, wherein the first plurality of data elements is stored in a first data system and the retrieval subunit of the first information unit specifies how to retrieve the first plurality of data elements from the first data system, and wherein the first data system takes a form of at least one of the following:
a distributed file system, wherein the first plurality of data elements is stored in a first file and the retrieval subunit of the first information unit specifies a directory of the first file and a location of the first plurality of data elements in the first file;
a key-value store, wherein the first plurality of data elements is stored as a value in a first key-value pair and the retrieval subunit of the first information unit specifies the key of the first key-value pair;
a data system which is at least one of: a relational database system, a statistical data analysis platform, or a document store, and wherein the retrieval subunit of the first information unit specifies a method of acquiring the first plurality of data elements as a result of at least one of: a SQL statement, a statistical operation, or a text search query.

6. The method according to claim 1, wherein data elements in the first plurality of data elements are information units describing pluralities of more detailed data elements, and wherein the summary subunit of the first information unit includes a summarized information about all pluralities of more detailed data elements described by information units in the first plurality of information units.

7. The method according to claim 6, the data processing system further comprising a document store, wherein a first document in the document store includes the first plurality of information units, a metadata of the first document in the document store includes the summarized information about all more detailed data elements described by information units in the first plurality of information units, and a key of the first document in the document store encodes a context of using the first plurality of information units by the data processing system.

8. The method according to claim 7, wherein the data query is specified against a relational data model, and wherein at least one of the following:
the first plurality of information units represents values of tuples in a first cluster of tuples over a first column in a first table of the relational data model and the key of the first document in the document store encodes an identifier of the first table, an identifier of the first column, and an identifier of the first cluster of tuples, and
the first plurality of information units represents vectors of values of tuples in the first cluster of tuples over a set of columns in the first table of the relational data model and the key of the first document in the document store encodes the identifier of the first table and the identifier of the first cluster of tuples in the first table.

9. The method according to claim 1, wherein the total information included in the retrieval subunit and the summary subunit of the first information unit represents less information than all unique data elements in the first plurality of data elements.

10. The method according to claim 1, the data processing system further comprising a plurality of processing agents, wherein the first processing agent is connected with the data processing system and other processing agents via a communication interface.

11. The method according to claim 10, wherein the data processing system assigns the first processing agent to store the first plurality of data elements, and wherein the assignment is made according to at least one of a predefined maximum amount of data elements allowed to be stored by the first processing agent or a degree of similarity of the summary subunit of the first information unit to summary subunits of information units describing pluralities of data elements stored by the first processing agent.

12. The method according to claim 11, wherein the data processing system assigns the first processing agent to resolve the data query, and wherein the assignment is made according to an amount of data elements selected as sufficient to resolve the data query that are not stored by the first processing agent comparing to other processing agents.

13. The method according to claim 10, wherein the data query is received together with an execution plan including a sequence of data operations, a result of a last data operation representing the result of the data query, the method further comprising:
using summary subunits of information units stored by the data processing system to select a set of information units describing data elements that are sufficient to resolve the first data operation;
assigning the first processing agent to resolve the first data operation and using retrieval subunits of information units in the selected set of information units to retrieve data elements that are sufficient to resolve the first data operation;
deriving a result of the first data operation as a plurality of new data elements and creating a new information unit, wherein its retrieval subunit specifies how to access the result of the first data operation at the first processing agent and its summary subunit includes a summarized information about the result of the first data operation; and
returning the new information unit for further use by the data processing system.

14. The method according to claim 13, wherein there are at least two data operations in the execution plan, the method further comprising:
if resolving a second data operation requires the result of the first data operation, then using the summary subunit of the new information unit describing the result of the first data operation to select a set of information units describing data elements that are sufficient to resolve the second data operation; and
if resolving the second data operation does not require the result of the first data operation, then assigning a second processing agent to resolve the second data operation and resolving the second data operation in parallel to the first data operation.
